(19) United States
(12) Patent Application Publication
(10) Pub. No.: US 2025/0234822 A1
(43) Pub. Date: Jul. 24, 2025

(54) PREDICTIVE METHOD AND SYSTEM FOR OPTIMIZING RESOURCE USE AND CROP PRODUCTIVITY IN INDOOR FARMING

(71) Applicant: Hamad Bin Khalifa University, Doha (QA)

(72) Inventors: Antonio Sanfilippo, Doha (QA); Abdellah Islam Kafi, Doha (QA); Raka Jovanovic, Doha (QA); Sa'd Abdel-Halim Shannak, Doha (QA); Noormazlinah Binti Ahmad, Doha (QA); Nasser Al Khalaf, Doha (QA)

(21) Appl. No.: 19/022,610

(22) Filed: Jan. 15, 2025

Related U.S. Application Data
(60) Provisional application No. 63/622,257, filed on Jan. 18, 2024.

(51) Int. Cl. A01G 31/00; G06N 20/00

(52) U.S. Cl. CPC A01G 31/011; G06N 20/00

(57) ABSTRACT

The present disclosure relates to the field of Controlled Environment Agriculture (CEA). It details a predictive method and system for optimizing the use of resources and crop productivity in indoor farming across an entire crop cycle. The present disclosure provides for a predictive method and system for optimizing resource use and crop productivity in indoor farming. According to one aspect of the present disclosure, a predictor for optimizing resource use and crop productivity in indoor farming. According to a second aspect of the present disclosure, a predictive system for optimizing resource use and crop productivity in indoor farming. According to a third aspect of the present disclosure, a method of using a predictive system for optimizing resource use and crop productivity in indoor farming.

### PRIORITY CLAIM AND CROSS-REFERENCE TO RELATED APPLICATIONS

The present application claims the benefit of U.S. Provisional Application No. 63/622,257 filed Jan. 18, 2024, which is incorporated herein by reference in its entirety.

### BACKGROUND

Digital twin models of greenhouses provide an environment where choices in resource use can be explored with reference to their outputs, e.g., crop yield and the ensuing carbon footprint.

The existing literature describes a system that uses Artificial Intelligence (AI) to optimize plant growth by adjusting light intensity for plants. The system uses computer vision with deep-learning models to automatically analyze plant biomass and chlorophyll fluorescence (light that is not used for photosynthesis and is re-emitted from the plant) to modify environmental factors within the indoor farm to improve crop yield.

The existing literature also describes a method for using Internet-of-Things (IoT) technology and wireless communication (e.g., Wi-Fi, Bluetooth, Z-wave, Zigbee, X-bee, Lora, Thread, TCP/IP, 3G, 4G, and 5G) to record and control parameter that regulate plant health and growth in indoor farming.

The existing literature also describes a technique for controlling an agricultural system by using sensor and computing technology to record and analyze environmental (e.g., temperature), lighting, and plant status (e.g., presence or absence of disease) to take corrective measures where needed.

Therefore, a need exists for a predictive method and system for optimizing resource use and crop productivity in indoor farming.

### SUMMARY

The present disclosure provides for a predictive method and system for optimizing resource use and crop productivity in indoor farming.

According to one non-limiting aspect of the present disclosure, an exemplary embodiment of a predictor for optimizing resource use and crop productivity in indoor farming.

According to a second non-limiting aspect of the present disclosure, an exemplary embodiment of a predictive system for optimizing resource use and crop productivity in indoor farming.

According to a third non-limiting aspect of the present disclosure, an exemplary embodiment of a method of using a predictive system for optimizing resource use and crop productivity in indoor farming.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 shows a system overview of the Disclosed Invention, according to an example embodiment of the present disclosure.

FIG. 2 also shows a system overview of the a greenhouse digital twin of the Disclosed Invention, according to an example embodiment of the present disclosure.

FIG. 3 shows an overview of a greenhouse sensor network, according to an example embodiment of the present disclosure.

FIG. 4 shows a sample output of multi-objective optimization of the Disclosed Invention, according to an example embodiment of the present disclosure.

FIG. 5 shows an assessment of alternative scenarios evaluating the use of resources (e.g., energy) vs. crop yield in indoor farming of the Disclosed Invention, according to an example embodiment of the present disclosure.

### DETAILED DESCRIPTION

The present disclosure generally relates to a predictive method and system for optimizing resource use and crop productivity in indoor farming. Moreover, the Disclosed Invention relates to the field of Controlled Environment Agriculture (CEA). It details a predictive method and system for optimizing the use of resources and crop productivity in indoor farming across an entire crop cycle.

The Disclosed Invention describes a Predictive Enterprise Resource Planning (ERP) method and system that enables proactive decision making in the farming industry through the collection and analysis of data on environmental conditions, capital and operational costs, expected productivity and ensuing revenues relevant to the farming context. The main components of the system are: a data component (that enables the user to collect data relevant to farming in real time through sensors installed in each cultivation area; collect local meteorological and environmental data relevant to farming from weather data services, and provide capital and operational costs relevant to farming operations); a digital twin of each cultivation area that relates data relevant to farming at each point of the crop cycle to predict crop output at the end of the cycle; an optimization component that identifies the best tradeoffs between the current use of resources relevant to farming and final (expected) crop output; and a technoeconomic analysis component that for each optimized tradeoff scenario identifies the net return above total costs, e.g., on an annual basis.

The preferred embodiment detailed in this disclosure focuses on a hydroponic greenhouse with evaporative cooling operating in a hot desert climate. The same method and system apply to other cultivation types including other forms of indoor farming and outdoor farming relative to other climates.

The data collection component uses: a network of IoT sensors integrated with a local and cloud communication infrastructure to monitor, record and store parameter values inside and outside the greenhouse relevant to plant health and growth during the crop cycle; a connection to a local weather service to access meteorological and environmental data relevant to farming; and user interface to allow the user to provide capital and operational costs relevant to farming operations.

The Disclosed Invention uses a network of IoT sensors integrated with a local and cloud communication infrastructure to monitor, record and store parameter values inside and outside the greenhouse relevant to plant health and growth during the crop cycle.

At a given interval (e.g., every hour, every day) the parameters values collected are used as input to a digital twin of the greenhouse to project the expected resource use, crop productivity and carbon footprint through the end of the crop cycle. Greenhouse sensors monitor energy use, environmental conditions (e.g., temperature, humidity, luminosity, CO2), soil parameters (e.g., pH, soil conductivity, dissolved oxygen), water parameters (salinity, flow), and plant health parameters (e.g., chlorophyll content, presence/absence of disease) inside the greenhouse. Parameter values outside the greenhouse are obtained through existing meteorological services, e.g., the National Solar Radiation Database (NSRDB), or meteorological sensor installed outside the greenhouse.

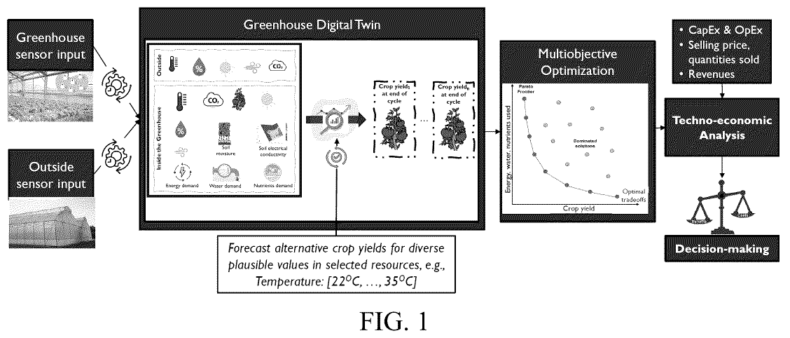

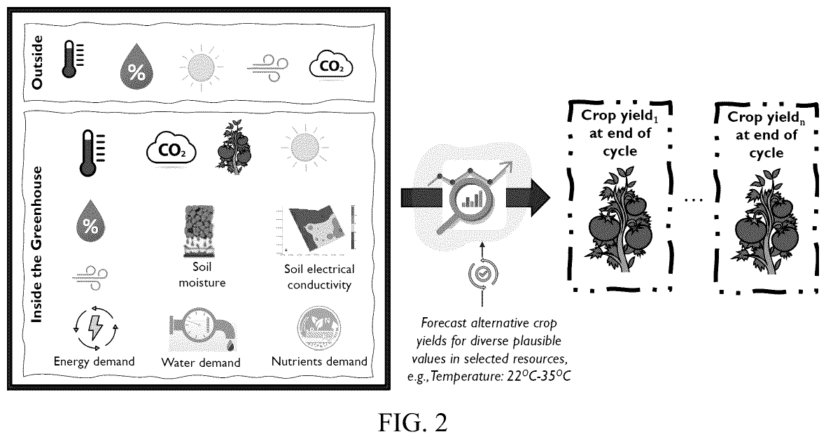

The output data of the greenhouse digital twin is analyzed by a multi-objective optimization component to identify tradeoffs between resource use and crop productivity across diverse scenarios. The output of optimization together with additional external inputs including land, labor, capital, and operational costs is finally examined by a technoeconomic component. The technoeconomic component assesses the return on investment emerging from each scenario to provide the decision-maker with the information she needs to select the best strategy to achieve her goals. FIGS. 1 and 2 provide a graphic overview of the system.

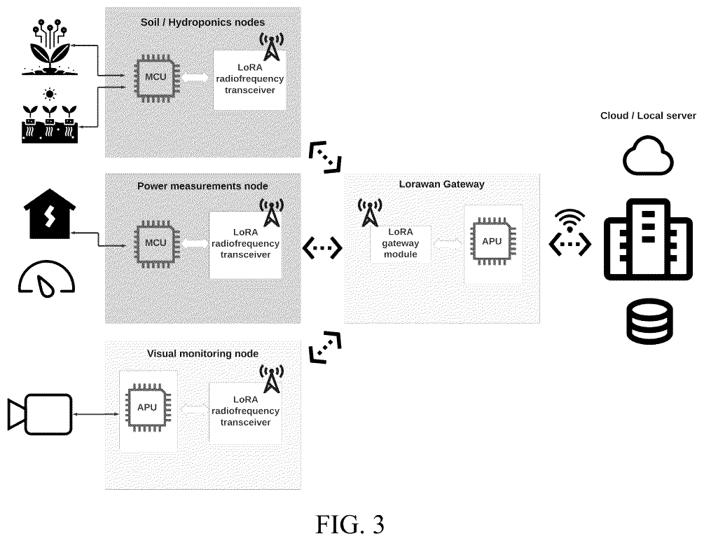

Greenhouse Sensor Input—Greenhouse sensor input provides information inside the greenhouse which impact crop productivity, e.g., temperature, relative humidity, luminosity, pH, dissolved oxygen, soil conductivity, energy usage, CO2. This information is obtained through a network composed by sensor devices attached to microcontroller units that are enabled for wireless communication. FIG. 3 provides a graphic embodiment of the greenhouse sensor network where a radiofrequency network protocol (LoRa, LoRaWAN) is used to communicate all the sensor data collected to a gateway from where the data are then sent to a cloud server for processing and data warehousing. Other embodiments of the greenhouse sensor input are possible using wired local networks with or without a connection to the cloud. In the latter case, processing and storage is handled locally.

Outside Sensor Input—Data about meteorological conditions outside the greenhouse which impact crop productivity inside the greenhouse (e.g., temperature, solar radiation) are obtained through existing meteorological services (e.g., the National Solar Radiation Database, NSRDB) and routed to the greenhouse digital twin directly or through an intermediate database. Alternatively, or in combination with existing meteorological services, (additional) data about meteorological conditions outside can be obtained from sensors installed outside the greenhouse.

Digital Twin—The digital twin includes a set of mathematical equations and/or models (e.g., differential equations and/or AI models) that take multiple greenhouse internal and external inputs to provide an estimation of the crop yield. An example of a greenhouse digital twin is described in the existing literature. Subject to the frequency of the input updates (e.g., daily, or hourly), the full crop cycle estimation is recomputed to provide an update of the expected crop yield at the end of the plantation cycle. The digital twin parameters are updated dynamically in response to both sensors' inputs and crop yield feedback that can be obtained manually or using an automatic sensing solution such AI computer vision algorithms. In the present embodiment, the digital twin is implemented as a multivariate machine learning model to forecast crop yield using inputs from various sensor that monitor the environmental and crop related parameters. These sensors collect real-time measurements on temperature, humidity, light intensity, soil electrical conductivity, soil moisture, soil temperature, CO₂ level, pH level. The model is trained on the dataset emerging from these measurements and corresponding crop yield quantities to forecast parameters profiles and the ensuing crop production. The Deep Neural Network (DNN) model used to develop the forecasting model uses the following data structure:

$$X = [ \begin{matrix}{x}_{11} & {x}_{12} & … & {x}_{1 n} \\ {x}_{21} & {x}_{22} & … & {x}_{2 n} \\ ⋮ & ⋮ & ⋱ & ⋮ \\ {x}_{m 1} & {x}_{m 2} & … & {x}_{mn}\end{matrix} ] , X ∈ {ℝ}^{m \times n}$$

where:
X: is the input data matrix
m: Number of sensors.
n: Number of data points.
x: Value of the i-th sensor for the j-th data point.
   The DNN forecasting function is given by the following equation:

$$\hat{Y} = f ( X ) = {A}^{( L )} = {σ}^{( L )} ( {W}^{( L )} {A}^{( L - 1 )} + {b}^{( L )} )$$

where:
Ŷ: Predicted yield output.
L: Total number of layers in the network.
A^{(l)}: Activations (outputs) of layer l, where l=1, 2, . . . , L.
W^{(l)}: Weight matrix of layer l, W^{(l)}∈ [symbol] ⁿ^{ₗ}^{×n}^{ₗ₋₁}
b^{(l)}: Bias vector of layer l, b^{(l)}∈ [symbol] ⁿ^{ₗ}.
σ^{(l)}: Activation function of layer l.
Ŷnₗ: Number of neurons in layer l.

For further details on DNNs see Samek, W., Montavon, G., Lapuschkin, S., Anders, C. J. and Müller, K. R., 2021, Explaining deep neural networks and beyond: A review of methods and applications, Proceedings of the IEEE, 109(3), pp. 247-278. Other forecasting models including DNN variants such as Long Short-Term Memory and traditional forecasting methods based on machine learning algorithms (e.g., support vector regression) and statistical and econometric methods (e.g. autoregressive integrated moving average) can also be used as alternative forecasting algorithms.

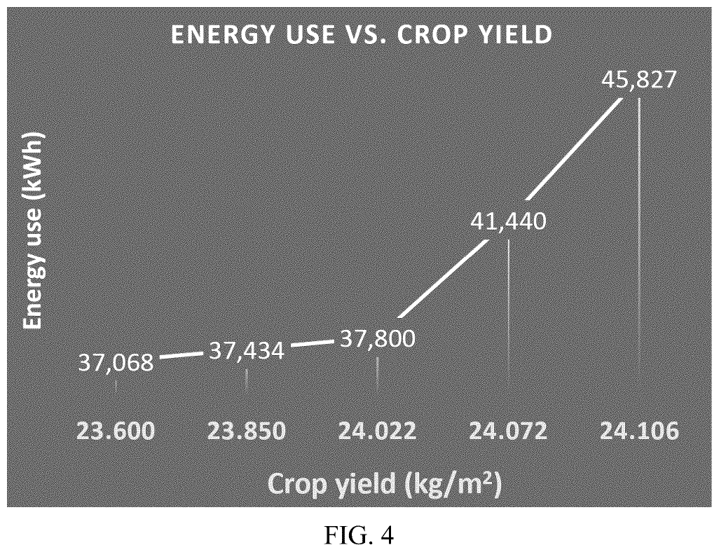

Optimization—Each (expected) full crop cycle estimation generated by the Digital Twin is analyzed by the optimization component. First, some intervals of variation are defined for selected parameters that enable the generation of “non-dominated solutions”, i.e., solutions where no objective can be improved without a simultaneous detriment of at least one of the other objectives. In one embodiment, the interval [15 C, 35 C] is selected for the temperature parameter inside the greenhouse. Within that interval, each of many intermediate temperature values is used as input to the greenhouse digital twin together with the other input values to generate alternative scenarios. The set of alternative scenarios are then used as input to an optimization algorithm that identifies the optimal (non-dominated) solutions in a multi-objective optimization problem in an efficient manner. The emerging set of optimal solutions is referred to as the “Pareto Front”. In one embodiment, the multi-objective optimization problem focuses on the identification of tradeoffs between energy use and crop yield, as shown in FIG. 4, which is obtained applying the multi-objective version of the genetic algorithm, as shown below. Other multi-objective optimization methods can be used to achieve the same objective. The model optimizes the use of controllable parameters: T̅ the desired constant temperature inside the greenhouse over the growth cycle and V̅ the desired constant air circulation speed inside the greenhouse over the growth cycle. The model uses a structure N_{c} containing non-controllable environmental factors such as outside temperature, solar radiation, and other climate-related variables. The first objective is total energy use E which is equal to the sum of energy used for cooling and fan energy. Cooling energy (E_{c}), which depends on greenhouse surface area (A), thermal properties (U), and the temperature difference between inside and outside (ΔT). The Fan Energy (E_{f}) depends on volumetric airflow rate (V_{FR}), air density (ρ), desired wind speed (V), and fan efficiency (η).

The optimization focuses on finding the values of T̅ and V̅ that balance energy efficiency and crop yield. Due to the computational complexity and the generalized nature of the tomato growth model, the optimization assumes constant values for T̅ and V̅ over the entire growth cycle. The total energy consumption E(T̅,V̅,N_{c}). The tomato yield is evaluated using the growth model corresponding to the function Y(T̅,V̅,N_{c}). To solve this multi-objective optimization problem, the Non-Dominated Sorting Genetic Algorithm II (NSGA-II) algorithm is employed. The task of finding the Pareto Front can be done with alternative methods like Multi-Objective Evolutionary Algorithm based on Decomposition (MOEA/D), Pareto Envelope-based Selection Algorithm II (PESA-II); for further details see Deb, K., Pratap, A., Agarwal, S., & Meyarivan, T. A. M. T. (2002) A fast and elitist multiobjective genetic algorithm: NSGA-II. IEEE transactions on evolutionary computation, 6(2), 182-197. Other methods such as Normal Boundary Intersection (NBI), Modified Normal Boundary Intersection (NBIm), Normal Constraint (NC), Successive Pareto Optimization (SPO), and Directed Search Domain (DSD) can also be used as an alternative to NSGA-II.

Technoeconomic Analysis—In the Disclosed Invention, a comprehensive approach to technoeconomic analysis is applied, with a particular focus on additional operational costs, as most of the expenses here are attributed to retrofitting existing greenhouses by introducing new sensors to enhance efficiency. The present embodiment operates under the assumption that capital costs have already been covered and focus on the assessment of the technical and economic feasibility (TEA) of tomato greenhouse farming in Qatar, with a strong emphasis on its economic viability, as shown below. Wider or narrower assumption can be applied, with reference to the same or different crops, as required by the application context.

The analysis described in the present embodiment delves into several critical facets, including capital and ongoing expenditures, yield projections, revenue forecasts, and the determination of the project's breakeven point. Furthermore, to ensure a comprehensive assessment, various stages of tomato production within the greenhouse environment were scrutinized. This entails evaluating the requisites and associated costs of the nursery phase, land preparation and planting, harvesting procedures, and the packaging processes. By examining each stage meticulously, the technology attains a comprehensive understanding of the resources, labor, and expenditures entailed across the entire production cycle.

The analysis delivers a robust decision tool that empowers both operators and stakeholders in the realm of greenhouse tomato cultivation. This tool serves as a pivotal instrument for defining unit prices of greenhouse-grown tomatoes while ensuring favorable financial outcomes. Moreover, it elucidates the necessary production quantities, thereby shedding light on production efficiency and its quantified monetary value. The analysis begins with determining the Total Cost (C_{_total}), which encompasses both fixed costs and variable costs:

$${C}_{total} = {C}_{fixed} + {C}_{variable} .$$

Fixed costs, such as equipment depreciation, rent, or insurance, remain constant regardless of production levels, whereas variable costs, including raw materials, energy, and labor, fluctuate with production output. Next, the Break-even Yield (Y_break-even) is calculated to determine the minimum production required to cover a specified cost level. This is given by:

$${Y}_{b r eak - even} = {C}_{target} / {P}_{s a l e s}$$

where:
C_{target} is the cost level being evaluated (e.g., variable costs, cash costs, or total costs).
Pₛₐₗₑₛ is the average sales price per kilogram.

Similarly, the Break-even Price (P_break-even) is calculated to identify the minimum price needed to equate total revenue and total costs for a specific production level. It is expressed as:

$${P}_{b r eak - even} = {C}_{total} / {Y}_{p r o d u c t i o n}$$

where: Y_{production} is the production quantity in kilograms.

The analysis proceeds to evaluate Profit (R_net), which measures returns after accounting for total costs. It is calculated as:

$${R}_{net} = ( {P}_{s a l e s} \cdot {Y}_{s a l e s} ) - {C}_{t otal}$$

where: Yₛₐₗₑ is the annual sales quantity in kilograms.

To understand how production yield impacts pricing, a Sensitivity Analysis for Break-even Price is conducted. It employs the same formula as the break-even price but evaluates variations in production yield, allowing for the assessment of how changes in yield affect the required price to cover costs and achieve profitability.

$${P}_{b r eak - even} = {C}_{total} / {Y}_{p r o d u c t i o n}$$

The Total Revenue (R_total) is calculated next to determine overall income from sales. It is given by:

$${R}_{total} = {P}_{s a l e s} \cdot {Y}_{s a l e s}$$

Operating costs are further broken down to evaluate unit-level efficiency. The Operating Cost per Unit (C_operating, unit) is determined as:

$${C}_{o p e r a ting , unit} = {C}_{operating} / {Y}_{production}$$

Similarly, the Harvesting and Packing Cost per Sales Unit (C_HP, unit) is calculated as:

$${C}_{H P , unit} = \{ {C}_{harvesting} + {C}_{p a c k i n g} \} / \{ {Y}_{s a l e s} \}$$

Profitability is assessed using the Profit Margin (M), which expresses net profit as a percentage of total revenue:

$$M = \{ {R}_{net} \} / \{ {R}_{total} \} \times 100$$

Finally, the long-term viability of the project is evaluated through the Internal Rate of Return (IRR). This requires solving the net present value (NPV) equation:

$$NPV = {\sum }_{t = 0}^{n} \frac{{R}_{t} {\_C}_{t}}{{( 1 + r )}^{t}}$$

where
R_{t_} is the revenue in year t.
Cₜ is the cost in year t.
n is the project duration in years.

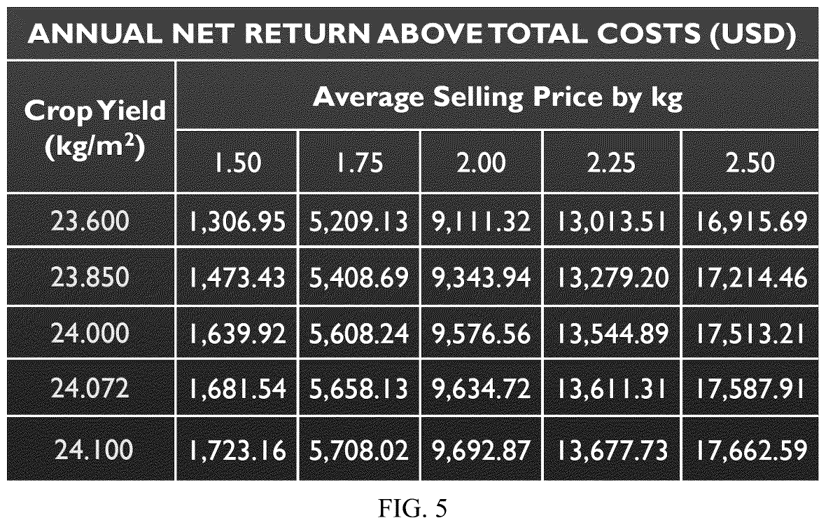

The table below provides the corresponding average selling prices associated with varying production quantities. Furthermore, by delineating the financial returns, our analysis paints a comprehensive picture of the economic landscape. FIG. 5 provides a technoeconomic analysis of the scenarios shown in FIG. 4. This invaluable tool equips decision-makers with the insights needed to make informed choices that drive profitability and sustainability in greenhouse tomato farming.

TABLE 1
Average selling prices associated, with varying production quantities.
ANNUAL NET RETURN ABOVE TOTAL COSTS

| | | Average Selling Price | | | | |
|---|---|---|---|---|---|---|
| | | $1.50 | $1.75 | $2.00 | $2.25 | $2.50 |
| Annual | 9,216 | ($5,485) | ($3,181) | ($877) | $1,427 | $3,731 |
| Sales | 10,368 | (.$3,878) | ($1,286) | $1,306 | $3,898 | $6,490 |
| Quantity | 11,520 | ($2,271) | $609 | $3,489 | $6,369 | $9,249 |
| | 12,672 | ($665) | $2,503 | $5,671 | $8,839 | $12,007 |
| | 13,824 | $942 | $4,398 | $7,854 | $11,310 | $14,766 |
| | 20,000 | $9,555 | $14,555 | $19,555 | $24,555 | $29,555 |
| | 30,000 | $23,502 | $31,002 | $38,502 | $46,002 | $53,502 |
| | 40,000 | $37,449 | $47,449 | $57,449 | $67,449 | $77,449 |
| | 50,000 | $51,395 | $63,895 | $76,395 | $88,895 | $101,395 |
| | 55,000 | $58,369 | $72,119 | $85,869 | $99,619 | $113,369 |
| | 60,000 | $65,342 | $80,342 | $95,342 | $110,342 | $125,342 |

Achieving food self-sufficiency requires farming activities to take place all year-round. This is a challenging endeavor in Qatar due to extreme weather conditions and the scarcity of arable land and water resources. The use of indoor farming practices such as hydroponics and aquaponics can address the lack of arable land and provide one of the most water-efficient solutions for irrigating food crops. However, indoor farming in high temperatures during most of the year requires extensive use of water for cooling in addition to irrigation. Whether sourced from underground reservoirs, which overall present higher salinity than cooling systems and food crops can accept, or the sea, such extensive use of water entails substantial investments in energy for desalination and water pumping and transport processes. The alternative use of air conditioning is equally or more energy intensive. The optimization of energy efficiency in the production of high-quality vegetables is therefore a key challenge in achieving sustainability for indoor farming in Qatar.

The greenhouse technology described in this disclosure is unique in providing a way to dynamically assess the tradeoffs in the use of resources (e.g., energy) against expected outputs (e.g., crop productivity) to enable informed decision-making through optimization and technoeconomic analysis. This technology is based on the combination of Internet of Things (IoT) and Artificial Intelligence (AI) technologies.

The Disclosed Invention has the ability to project crop productivity at the end of the crop cycle using information from the beginning through any stage of the crop cycle. The benefit is dynamic predictive knowledge about crop yield on current farming practices. The Disclosed Invention has the ability to generate alternative end-of-cycle crop productivity scenarios for each crop productivity projection. The benefit is dynamic predictive knowledge about crop productivity scenarios emerging from alternative farming practices. The Disclosed Invention has the ability to identify crop productivity scenarios that offer optimal tradeoffs between resources (e.g., energy, water, nutrients) and crop yield at any stage of the crop cycle. The benefit is dynamic predictive knowledge about efficient use of resources. The Disclosed Invention has the ability to perform a technoeconomic analysis on optimal crop productivity scenarios at any stage of the crop cycle. The benefit is dynamic predictive knowledge about net return on optimal crop productivity scenarios as a function of crop output, capital costs, operational costs, and expected selling price-see FIG. 5.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A predictive system for optimizing resource use and crop productivity in indoor farming, the system comprising:
an indoor farm, wherein the indoor farm comprises an internal portion and an external portion,
a data component,
a digital twin, wherein the digital twin is in communication with the data component,
an optimization component, wherein the optimization component is in communication with the digital twin, and
a technoeconomic analysis component, wherein the technoeconomic analysis component is in communication with the optimization component,
wherein the data component is configured to collect real-time farming data,
wherein the data component is configured to collect external meteorological and environmental data,
wherein the digital twin is configured to receive the real-time farming data and the external meteorological and environmental data,
wherein the digital twin is configured to predict crop yield output at the end of a crop cycle,
wherein the optimization component is configured to identify optimal tradeoffs between a current use of resources and an expected crop output, and
wherein the technoeconomic analysis component is configured to identify expenditures during an entire production cycle.

2. The system of claim 1, wherein the farm is on a hydroponic greenhouse with evaporative cooling, a hydroponic greenhouse with A/C cooling, an aquaponic greenhouse with evaporative cooling, an aquaponic greenhouse with A/C cooling, or any other form of controlled environment agricultural in closed spaces such as greenhouses, glasshouses, indoor farms, and growth chambers.

3. The system of claim 1, wherein the data component comprises a plurality of sensors, wherein the plurality of sensors are located on the internal portion and the external portion, and wherein the plurality of sensors are networked, and wherein the plurality of sensors are connected to a local and cloud storage component.

4. The system of claim 3, wherein the plurality of sensors monitor, record, and store the real-time farming data in the local and cloud storage components.

5. The system of claim 4, wherein each of the plurality of sensors comprises a microcontroller unit configured for wireless communication, wherein a radiofrequency network protocol is used to communicate the real-time farming data in the local and cloud storage components, and wherein the radiofrequency network protocol is one of LoRa or LoRaWAN, or any equivalent radiofrequency network protocol.

6. The system of claim 4, wherein the data component collects real-time farming data at user-defined intervals.

7. The system of claim 1, wherein the real-time farming data includes energy use, environmental conditions, temperature, humidity, luminosity, CO₂ levels, soil pH levels, soil conductivity, soil dissolved oxygen, water salinity, water flow, chlorophyll content, and presence/absence of disease plant disease.

8. The system of claim 1, wherein the data component further comprises a user interface, wherein the user interface is configured to receive user inputted capital and operational costs.

9. The system of claim 1, wherein the digital twin uses a model to predict expected resource use, crop productivity and carbon footprint through the end of the crop cycle, and wherein the model uses real-time farming data and external meteorological and environmental data as inputs.

10. The system of claim 9, where the model is a multivariate machine learning model, wherein the model is:
$$X = [ \begin{matrix}{x}_{11} & {x}_{12} & … & {x}_{1 n} \\ {x}_{21} & {x}_{22} & … & {x}_{2 n} \\ ⋮ & ⋮ & ⋱ & ⋮ \\ {x}_{m 1} & {x}_{m 2} & … & {x}_{mn}\end{matrix} ] , X ∈ {ℝ}^{m \times n}$$
where:
X is an input data matrix,
m is a number of sensors,
n is a number of data points, and
X is a value of the i-th sensor for the j-th data point.

11. The system of claim 10, wherein the digital twin uses a forecasting function, wherein the function is:
$$\hat{Y} = f ( X ) = {A}^{( L )} = {σ}^{( L )} ( {W}^{( L )} {A}^{( L - 1 )} + {b}^{( L )} )$$
where:
Ŷ is predicted yield output,
L is total number of layers in a network,
A^{(l)} is activations (outputs) of layer l, where l=1, 2, . . . , L,
W^{(l)} is weight matrix of layer l, W^{(l)}∈ [symbol] ⁿ^{ₗ}^{×n}^{ₗ₋₁},
b^{(l)} is bias vector of layer l, b^{(l)}∈ [symbol] ⁿ^{ₗ},
σ^{(l)} is activation function of layer l, and
Ŷnₗ is number of neurons in layer l.

12. The system of claim 9, wherein the model dynamically adjusts in response to both real-time farming data from a plurality of sensors and crop yield feedback from a user interface.

13. The system of claim 9, wherein the optimization component uses an optimization model to identify optimal tradeoffs between a current use of resources and an expected crop output, and wherein the optimization model uses expected resource use, crop productivity and carbon footprint through the end of the crop cycle from the digital twin as an input.

14. The system of claim 13, wherein the optimization model optimizes use of controllable parameters the desired constant temperature inside the indoor farm over the growth cycle (T̅) and a desired constant air circulation speed inside the indoor farm over a growth cycle (V̅), wherein the optimization model uses a structure N_{c} containing non-controllable environmental factors, wherein the optimization model's first objective is total energy use E which is equal to the sum of energy used for cooling and fan energy, wherein cooling energy (E_{c}) depends on indoor farm surface area (A), thermal properties (U), and the temperature difference between internal portion and external portion (ΔT), wherein the fan energy (E_{f}) depends on volumetric airflow rate (V_{FR}), air density (ρ), desired wind speed (V), and fan efficiency (η), and wherein the non-controllable factors include at least one of outside temperature, solar radiation, or other climate-related variables.

15. The system of claim 14, wherein the optimization model focuses on finding the values of T̅ and V̅ that balance energy efficiency and crop yield, wherein the optimization model assumes constant values for T̅ and V̅ over the entire growth cycle, wherein the total energy consumption is E(T̅,V̅,N_{c}), and wherein crop yield is calculated using growth model with a function Y(T̅,V̅,N_{c}).

16. The system of claim 9, wherein the technoeconomic component uses a technoeconomic model to calculate return on investment for various scenarios, and wherein the technoeconomic model uses optimal tradeoffs between a current use of resources and an expected crop output from the optimization component as an input.

17. The system of claim 16, wherein the technoeconomic component calculates Total Cost (Cₜₒₜₐₗ), Break-even Yield (Y_{break-even}), Break-even Price (P_{break-even}), Profit (Rₙₑₜ), Sensitivity Analysis for Break-even Price, Total Revenue (Rₜₒₜₐₗ), Operating Cost per Unit (C_{operating, unit}), Profit Margin (M); Harvesting and Packing Cost per Sales Unit (C_{HP, unit}), and Internal Rate of Return (IRR).

18. The system of claim 17, wherein Cₜₒₜₐₗ=C_{fixed}+C_{variable}, where Cₜₒₜₐₗ is fixed costs and C_{variable} is variable costs; wherein Y_{break-even}=C_{target}/Pₛₐₗₑₛ, where C_{target} is the cost level being evaluated and Pₛₐₗₑₛ is the average sales price per kilogram; wherein P_{break-even}=Cₜₒₜₐₗ/Y_{production}, where Y_{production} is the production quantity in kilograms; wherein Rₙₑₜ=(Pₛₐₗₑₛ·Yₛₐₗₑₛ)−Cₜₒₜₐₗ, where Yₛₐₗₑ is the annual sales quantity in kilograms; wherein Rₜₒₜₐₗ=Pₛₐₗₑₛ·Yₛₐₗₑₛ; wherein C_{operating, unit}=C_{operating}/Y_{production}; wherein C_{HP, unit}={C_{harvesting}+C_{packing}}/{Yₛₐₗₑₛ}; and wherein M={Rₙₑₜ}/{Rₜₒₜₐₗ}×100.

19. The system of claim 17, wherein the IRR represents the long-term viability of a project; wherein the IRR is calculated by the net present value (NPV) equation; wherein
$$NPV = {\sum }_{t = 0}^{n} \frac{{R}_{t} {\_C}_{t}}{{( 1 + r )}^{t}}$$
where Rₜ is the revenue in year t, Cₜ is the cost in year t, and n is the project duration in years.

20. The system of claim 18, wherein the Sensitivity Analysis calculates P_{break-even} using variations in production yield (Y_{production}), allowing for the assessment of how changes in yield affect the required price to cover costs and achieve profitability.
